(19) United States
(12) Patent Application Publication
(10) Pub. No.: US 2016/0098783 A1
(43) Pub. Date: Apr. 7, 2016

(54) SYSTEMS AND METHODS FOR GENERATION OF CUSTOMIZED ADVERTISING AND/OR CUSTOMIZED PROMOTION FOR PRODUCTS AND SERVICES

(71) Applicant: Pixter Media Ltd., Tel-Aviv (IL)

(72) Inventor: Assaf MARGALIT, Kfar-Vitkin (IL)

(21) Appl. No.: 14/503,431

(22) Filed: Oct. 1, 2014

(51) Int. Cl. G06Q 30/06

(52) U.S. Cl. CPC G06Q 30/0643; G06Q 30/0621; G06Q 30/0635

(57) ABSTRACT

There is provided a computerized method for simulating a product or service in an interactive user interface set to be added to a browsed web document, comprising: receiving data from a web document browsed to by a browser installed at a client terminal; analyzing the received data of the web document to identify at least one visual media item; generating a simulation of at least one product or service having the identified at least one visual media item integrated therein; and presenting the simulation at the client terminal within the browsed web document.

### BACKGROUND

The present invention, in some embodiments thereof, relates to customized promotion of products and services and, more specifically, but not exclusively, to systems and methods for web based promotion and/or advertizing of customized products as well as other types of products and services.

Users may buy physical items customized with images printed thereon, by visiting a website dedicated to offering such a service and purchasing the customized item from the website. First, the user selects a certain item for customization, for example, a mug or a t-shirt. Then the user uploads a desired image or photo from his/her own repository to the online-shop. The user then places an order for the selected item with the uploaded image printed thereon.

Users may select the specific on-line shop out of many available websites based on marketing that attracts the user to the specific on-line shop, for example, based on promotion by a search engine optimization (SEO) service.

Different methods have been developed for offering customized items to user.

For example, U.S. Pat. No. 8,756,114 discloses “A method of presenting an offer of an image-bearing product to a user provides access to a plurality of user image files. User image files are analyzed to obtain semantic information about the content of the plurality of image files. An offer for the image-bearing product based on the semantic information obtained, wherein the product uses at least one image from the plurality of image files. The offer is transmitted to the user.”

Additional background art includes:

U.S. Pat. No. 7,983,964

U.S. Pat. No. 8,019,654

U.S. Pat. No. 8,370,360

U.S. Pat. No. 8,554,641

U.S. Patent Application Publication No. US20020077930

U.S. Patent Application Publication No. US20030063116

U.S. Patent Application Publication No. US20030065587

U.S. Patent Application Publication No. US20080201218

U.S. Patent Application Publication No. US20100166394

U.S. Patent Application Publication No. US20110307294

International Patent Application Publication No. WO0150416

### SUMMARY

According to an aspect of some embodiments of the present invention there is provided a computerized method for simulating a product or service in an interactive user interface set to be added to a browsed web document, comprising: receiving data from a web document browsed to by a browser installed at a client terminal; analyzing the received data of the web document to identify at least one visual media item; generating a simulation of at least one product or service having the identified at least one visual media item integrated therein; and presenting the simulation at the client terminal within the browsed web document.

Optionally, the product is a customized product defined by the user.

Optionally, the simulation is presented within a customized banner displayed within the browsed web document.

Optionally, the method further comprises receiving, from the client terminal, a manual command selected by a user based on an interactive user interface containing the presented simulation, the command indicating selection of the certain product or service having the integrated visual media item.

Optionally, the method further comprises sending a work product order to at least one of a supplier and a manufacturing facility with instruction to manufacture or provide a physical version of the generated simulation, the physical version including the identified at least one visual media item physically applied to the product.

Optionally, the method further comprises sending a work product order to at least one of a service and a facility with instruction to provide a service or a non-customized product based on the generated simulation.

Optionally, the method further comprises displaying a detailed version of the generated simulation at the client terminal and providing editing functions to edit the integrated at least one visual media item for manufacturing.

Optionally, the generated simulation is automatically displayed in an interactive user interface added within the same web document from which the identified at least one visual media item has been extracted.

Optionally, the generated simulation is automatically displayed within the same web document from which the identified at least one visual media item as been extracted based on a predefined set of rules independent of user permission.

Optionally, the method further comprises displaying an icon within the web document in proximity to the identified at least one visual media item before presentation of the simulation; and presenting the simulation in response to a manual selection of the icon by a browsing user.

Optionally, the simulation is presented in response to at least one member selected from the group consisting of: a click of an icon, a click or hovering of the presented simulation, hovering a cursor over an icon, hovering a cursor over the presented simulation, a click of the at least one visual media item, and hovering the cursor over the at least one visual media item.

Optionally, the method further comprises automatically gathering data for analysis from previously browsed web documents based on a browsing history stored at the client terminal.

Optionally, analyzing comprises analyzing the received data to identify an image of a user of the client terminal, and generating comprises generating the simulation including the image of the product or service having the image of the user integrated therein.

Optionally, analyzing comprises analyzing the received data of the web document to identify at least one validated image or other media item suitable for physical application to a physical product, wherein the at least one validated image includes at least one of a resolution above a predefined resolution threshold and image dimensions above a predefined dimension threshold.

Optionally, analyzing comprises analyzing the received data of the web document based on at least one tag associated with each respective visual media item to identify certain types of the at least one visual media item, the at least one tag including descriptive information of the respective visual media item.

Optionally, the generated simulation includes multiple different products each having the same identified visual media item and/or each having different identified visual media items integrated therein, for display at the client terminal.

Optionally, the generated simulation includes one or more product each having multiple different identified visual media items integrated therein, for display to at the client terminal.

Optionally, one or both of the at least one product or service and the identified at least one visual media item integrated therein, are periodically changed while the web document is presented, to a different product or service and/or a different identified at least one visual media item integrated therein.

Optionally, the method further comprises analyzing at least one of a browsing behavior, a geographical location, and a personal profile of a user accessing the web document; wherein analyzing the received data comprising analyzing the received data of the web document to identify at least one image and/or relevant products and/or relevant services having personal significance to the user based on the analyzed at least one of behavior and profile of the user.

Optionally, the simulation comprises the product or service having a plurality of identified visual media items integrated therein as a collage.

Optionally, at least one of the receiving, the analyzing, and the generating are performed by software modules at a central server.

Optionally, at least one of the receiving, the analyzing, and the generating are performed by software modules at the client terminal.

Optionally, the method further comprises filtering the received data to exclude offensive or inappropriate visual media items.

Optionally, the method further comprises selecting a certain product or service based on one or both of suitability of the product or service to the user based on a demographic profile of the user, and an analysis of visual properties of the media item to form a visually appealing customized product with the certain product.

Optionally, the method further comprises transmitting, from the client terminal, information for creation of work data to a server; generating, at the server, the work data based on the information; and transmitting the work data, from the server, to at least one of an affiliate and a connected shop, for order fulfillment processing.

Optionally, the method further comprises triggering, based on selection of the simulation, a presentation of the product or service in a presentation window configured to enable purchase of the product or service through the presentation window.

Optionally, the simulation is delivered to the user as an email or an electronic message.

According to an aspect of some embodiments of the present invention there is provided a system for simulating a product or service in an interactive user interface set to be added to a browsed web document, comprising: a central server comprising: a client network interface configured to communicate with at least one client terminal over a network and to receive data from a web document browsed to by a browser installed on the client terminal, the received data including at least one visual media item; a product or service data repository configured to at least one of store and remotely access a plurality of product or service representations available from at least one product or service supplier; and a simulation generation module configured to generate a simulation of at least one product or service representation from the repository having the at least one visual media item integrated therein, and to provide the simulation to the network interface for presentation within the browsed web document at the client terminal.

According to an aspect of some embodiments of the present invention there is provided a system for simulating a product or service in an interactive user interface set to be added to a browsed web document, comprising: a hardware processor; a memory storing a script module containing program instructions for execution by the hardware processor, the script module including instructions for: receiving data from a web document browsed to by a browser, the received data including at least one visual media item; at least one of storing and remotely accessing a plurality of product or service representations available from at least one product or service supplier; and generating a simulation of at least one product or service representation from a repository having the at least one visual media item integrated therein, and providing the simulation for presentation within the browsed web document; wherein the hardware processor and the memory are included at one or both of a client terminal and a web server hosting the web document.

Optionally, the product is a customized product defined by the user.

Optionally, the script or part thereof is executed at the client terminal by a member selected from the group consisting of: browser application, toolbar, browser extension, and desktop application.

Optionally, the script or part thereof is executed at the web server as part of an add-on to the web document.

Optionally, the system further comprises a visual media analysis module configured to analyze the received data to identify the at least one visual media item, the visual media analysis module configured for program execution on at least one of the web server and the client terminal.

Optionally, one or both of the web server and the client terminal are configured for sending a work product order to a supplier server of a certain supplier offering the product or service of the generated simulation, with instructions to manufacture a physical version of the product including the at least one visual media item for physical application to the product, or to provide a service represented within the simulation, or to provide a non-customized product represented within the simulation. Optionally, the work product order includes metadata representing the details of the order.

Optionally, the data from the web document includes at least one member of a group consisting of: individual images, logos, symbols, emblems, photos, drawn illustrations, and rendered pictures.

Optionally, the system further comprises a data gathering module for program execution at the client terminal or at the web server, the data gathering module configured to access data stored on the client terminal and/or at the web server and/or remotely accessed through the client terminal, and provide the accessed data and/or instructions of how to access the data for analysis. Optionally, the simulation module is configured to access web document browsing history stored on the client terminal and/or at a remote server, and provide data from the browsed web documents for analysis. Optionally, the simulation module is configured to access a plurality of visual media or URLs of the visual media stored at least one of on the client terminal and remotely, and provide the accessed plurality of visual media for further handling of user intent.

Optionally, at least one of the web server and the client terminal comprises a data gathering module configured to access at least one publicly available social network web document of a user of the client terminal to gather data for analysis.

Optionally, the web document includes the at least one visual media item presented together with the web document.

Optionally, the at least one visual media item is obtained independently of the web document.

Optionally, the client terminal is a mobile device with communication elements configured to wirelessly communicate with a central server.

Optionally, the system further comprises a services module configured to redirect the user to a shop for purchase of the presented product or service, the shop presented in at least one of: another window, at another URL, a third party service with an affiliate agreement, and a third party service without an affiliate agreement.

Optionally, the entity that manages the shop manages at least one of: production of customized products, fulfillment of non-customized products or services, and communication with other supply services directly or via the third party service.

According to an aspect of some embodiments of the present invention there is provided a computer program product for computing a simulation of a customized product, a non-customized product, or a service, in an interactive user interface set to be added to a browsed web document, the computer program product comprising: one or more non-transitory computer-readable storage mediums, and program instructions stored on at least one of the one or more storage mediums, the program instructions comprising: program instructions for receiving data from a web document browsed to by a browser installed at a client terminal; program instructions for analyzing the received data of the web document to identify at least one visual media item; program instructions for generating a simulation of at least one product or service having the identified at least one visual media item integrated therein; and program instructions for presenting the simulation at the client terminal within the browsed web document.

Optionally, the computer program product is a customized product defined by the user.

Optionally, the computer program product is stored on a central server for download to a local installation on the client terminal

Optionally, the computer program product is stored on a first member selected from the group consisting of: on a remote server for remote access by a client terminal, locally on the client terminal, and on a content delivery network (CDN).

Optionally, at least some of the program instructions of the computer program product are stored on the selected first member, and at least some of the remaining other program instructions of the computer program product are stored on at least one second member different from the first member, the at least one second member selected from the group consisting of: on a remote server for remote access by a client terminal, locally on the client terminal, and on a CDN.

Optionally, the simulation is a customized banner designed to promote purchase at least one of: the presented customized product, the presented non-customized product, and the presented service.

Optionally, the computer program product further comprises program instruction to directly trigger a purchase of the product and service or re-direct a user to an external server to continue the purchase process.

Optionally, the computer program product or part thereof is configured for local program execution as part of at least one member selected from the group consisting of: a browser extension of a web browser stored on a client terminal, an add-on to a website site stored on a web-server, and a native mobile application stored on the client terminal.

According to an aspect of some embodiments of the present invention there is provided a computerized method for matching a product or service to a visual media item in an interactive user interface set to be added to a browsed web document, comprising: receiving at least one visual media item from a web document browsed to by a browser of a user installed at a client terminal; selecting a certain product or service for a plurality of products or services based on one or both of suitability of the product or service to the user based on a demographic profile of the user, and an analysis of visual properties of the media item to form a visually appealing customized product with the certain product; generating a simulation of at least one product or service having the identified at least one visual media item integrated therein; and presenting the simulation at the client terminal within the browsed web document. Optionally, the product is selected to form a visually appealing customizable product formed by having the visual media item printed on the selected product.

Unless otherwise defined, all technical and/or scientific terms used herein have the same meaning as commonly understood by one of ordinary skill in the art to to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of presenting a simulation of customized products and/or services to browsing users, in accordance with some embodiments of the present invention;

FIG. 2 is a block diagram of a system for presenting a simulation of customized products and/or services to browsing users, in accordance with some embodiments of the present invention;

FIGS. 3A-3C are schematic diagrams depicting different presentations of a simulation of a product or service having an identified visual medial integrated therein, in accordance with some embodiments of the present invention;

FIGS. 4A-4I are screen captures of an exemplary implementation of the simulated customized product or service, in accordance with some embodiments of the present invention;

FIGS. 5A-5B are charts depicting exemplary business models based on the systems and/or methods described herein, in accordance with some embodiments of the present invention; and

FIG. 6 is a block diagram of another exemplary system implementation, in accordance with some embodiments of the present invention.

### DETAILED DESCRIPTION

The present invention, in some embodiments thereof, relates to customized promotion of products and services and, more specifically, but not exclusively, to systems and methods for web based promotion and/or advertizing of customized products as well as other types of products and services.

An aspect of some embodiments of the present invention relates to systems and/or methods for identifying visual media, such as video content, image(s), animations, static images, and/or graphical elements within a webpage(s) browsed by a user and generating a simulation of one or more products or a simulation of a service having the visual media integrated therein, for example overlaid thereon. The simulation is automatically presented to the user, for example, in association with a graphical user interface facilitating placing a purchase order by the browsing user for the visual media enhanced product or for the service. The systems and/or methods allow users browsing web documents, such as webpages to be presented with previews of personalized and/or customized physical products having images retrieved from the webpage the user is currently browsing. Additionally or alternatively, users may be presented with previews of services and/or non-customized products having the identified images integrated with the advertising and/or promotion for the service and/or non-customized product, the advertising and/or promotion with the identified image displayed at the same webpage the user is currently browsing.

The customized product is defined by the user, as described herein.

In some embodiments, the simulation includes a product or service customized with the visual media item. The simulation is of the customized product or service. In other embodiments, the simulation itself is customized or personalized for a non-customizable product or service. The simulation itself is changed according to the certain visual media item being presented with the simulation. The non-customizable product or service may not be changed.

Optionally, icons, buttons, messages, and/or other user interface elements representing the simulation are automatically located onto the webpage. The full simulation is presented in response to the user activating the icon. In this manner, multiple simulations associated with multiple visual media items may be displayed on the same webpage, without cluttering the webpage.

The simulation may be presented on a web document that is independent of, and/or unrelated to the entity offering the customized product, the non-customized product, or the service depicted in the simulation. Exemplary entities include business entities (e.g., the company, person or corporation owning and/or operating the web document is different from that owning and/or operating the products and/or services), and technical entities (e.g., the web document is hosted on a server that is unaffiliated or unconnected with a server hosting the site offering the product and/or service). That is, the simulation may be presented on a web document of a site of a certain entity that does not offer customized products. Optionally, the web document is unrelated to an on-line shop or other customized product entity provider offering the customized product or service depicted in the simulation. For example, the web document is part of a news website, an image storage service, a sport team site, a celebrity site, a social media website, an image sharing service, a social network website, or a personal blog. The web document may be part of a routine web browsing session of the user, that is, the user may not necessarily actively select the web document in order to purchase customized products.

The simulation may be automatically generated and displayed on the webpage the user is currently browsing without receiving explicit permissions and/or instructions from the user. The visual media items may be retrieved from the browsed web document without receiving explicit permission and/or instruction from the user.

The extraction of visual media items and/or the automatic presentation on the browsed web document may be based on factors independent of explicit user permission as described herein, such as a set of rules independent of user permission, for example, the uniform resource locator (URL) of the web document, the resolution of the visual media element, the size of the web browser window, and/or other rules and/or instructions (manual or automatically) set by a control module of the simulation service. It is noted that although the user may authorize installation of a software module (e.g., browser extension, toolbar, plug-in) to enable generation of the simulation on browsed webpages, the user may not need to provide additional explicit permission and/or instructions for automatic generation of the simulation on visited web documents. In such a case, the simulation is automatically generated and displayed on the webpage the user is browsing, based on the installed module, without receiving additional explicit permission and/or instructions. Alternatively, the to installation proceeds without specific authorization from the user.

Optionally, the user browsing a web document is presented with visual media items depicting the user him/herself, and/or other people related to the user (e.g., at social network websites of the user, at an online data repository). In such a case, the generated simulation may be based on the visual media items depicting the user and/or people related to the user, on products and/or services as described herein.

Alternatively, the visual media items may be independent from the browsing user, and/or otherwise unaffiliated with the browsing user, other than the browsing user browsing the web document that includes the visual media items. The visual media items may not be owned by the user, friends of the user, and/or family of the user. The visual media items may not display images of the user, associated with the user, family of the user, and/or friends of the user. The visual media items may not include images stored by the user, for example, stored on an online data repository, and/or stored on a site of the user such as a social network site of the user (regardless of the owner of the images being the social network site or the user). Alternatively, as described herein, the visual media items may be related to the user (or friends or family), for example, pictures of friends of the user, or pictures owned by family of the user.

Optionally, visual media is extracted from the webpage that the user is currently browsing, for example screenshot(s) and/or one or more logos, symbols, emblems, photos, drawn illustrations, and rendered pictures, individual images, and/or frames from a video, which are rendered by a browser presenting the webpage. The identified visual media may be images currently viewed by the user on the screen. In such a case, the images appear both at the native location within the webpage and another location that presents the product and/or service offered for sale, optionally, on a window or a sub-window within the web document and/or web browser.

Alternatively or additionally, images are extracted from webpages previously visited by the user (for example, based on the browsing history of the user, which may be stored on the client terminal and/or at a remote server), and/or from social network sites of the user. In such a case, the identified image may be of the browsing user, for example, an image of the user extracted from the social network profile of the user, or an image of the children of the user extracted from the social network webpage of the user.

Optionally, the visual media is displayed on a simulation of physical products as a preview of what the images attached to the products would look like upon manufacturing, for example, printed or adhered to cups, mugs, smart-phone case, t-shirts, greeting cards, canvas, photo albums, photo prints, and photo album covers.

Alternatively or additionally, the images are integrated (for example, pasted or overlaid) within advertisements for certain services and/or for certain non-customizable products, for example, the image of the face of the user or somebody related to the user is pasted into a picture of a beach as part of an advertisement for an island beach resort vacation sale, the image of the user is presented near a car for sale, the image of the user is simulated after skin treatment by a cosmetic being promoted, the image of the user is simulated wearing clothing items being sold (e.g. necklace, a belt, a tie, a hat).

The visual media is automatically identified and extracted. The user is not required to upload and/or provide his/her own visual media(s) and/or to mark existing visual media. The customized products having the applied visual media, for example, printed (or manufactured in other ways) visual media may be displayed and offered for sale on the same webpage from which the applied images were extracted, optionally within a customized banner. The user may preview the customized product and/or purchase the customized product based on the window or banner. The user does not need to specifically access a certain on-line shop for ordering the product before browsing the web document. The user may first browse the web document, and then access the on-line shop based on the simulation presented on the web document.

Optionally, images currently being viewed by the user on a certain webpage are identified and/or selected for preview, instead of, for example, only text from the webpage (unless the text appears as an image, for example, styled text or a logo), metadata from the webpage, and data from the URL, for example, the name of a social network webpage user and/or the like. Optionally, text, URL data, and/or metadata within the web document are integrated together with images from the same web document, and presented as part of the simulation of the product and/or service, as described herein. For example, the name of the user is retrieved (e.g., from a social network site of the user) and displayed or otherwise integrated within a simulation for a product and/or service that includes a picture of the user.

The user may select a certain product or service having the integrated visual to media item for physical manufacturing and/or for supplying of an existing product and/or service, based on the generated simulation. The selection may be performed, for example, by the user clicking on the interactive user interface (for example, window) presenting the simulation. A work product order may be automatically generated and transmitted from a central server processing the selection request, to a supplier of a manufacturing facility able to manufacture the physical version of the presented simulation (e.g., by transmitting the data to a server of the manufacturer, to a fax machine, by phone, and/or by email). Alternatively, the work product order is generated and transmitted to a service provider, to provide the service to the user (e.g., to a server, or based on other methods of information transfer).

An aspect of some embodiments of the present invention relates to systems and/or methods for matching a customizable product, a non-customizable product and/or a service to a visual media item. Optionally, the product or service is selected based on suitability to a user viewing the visual media item, such as based on an analysis of a demographic profile of the user. Alternatively or additionally, a customizable product is selected to form a visually appealing customized product when the visual media item is printed thereon, such as based on an analysis of visual properties of the visual media item.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable to combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages, for example, Java, PHP, python, Rubi, JavaScript and browser languages. The computer readable program instructions may execute entirely to on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable to apparatus or other device to produce a computer implemented process, such that the instructions which execute on the computer, other programmable apparatus, or other device implement the functions/acts specified in the flowchart and/or block diagram block or blocks. The program instructions may include a browser executing a script.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

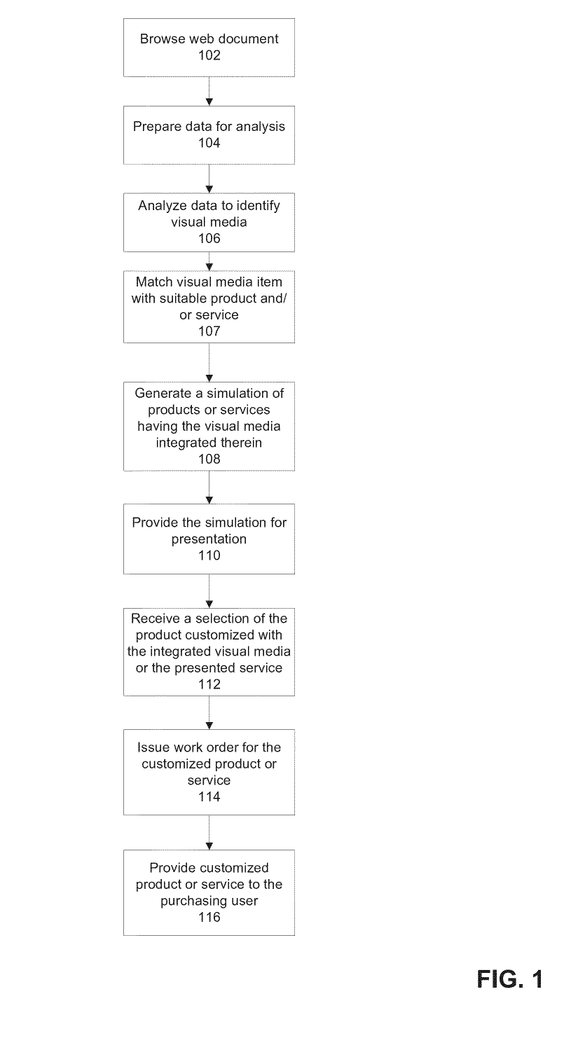

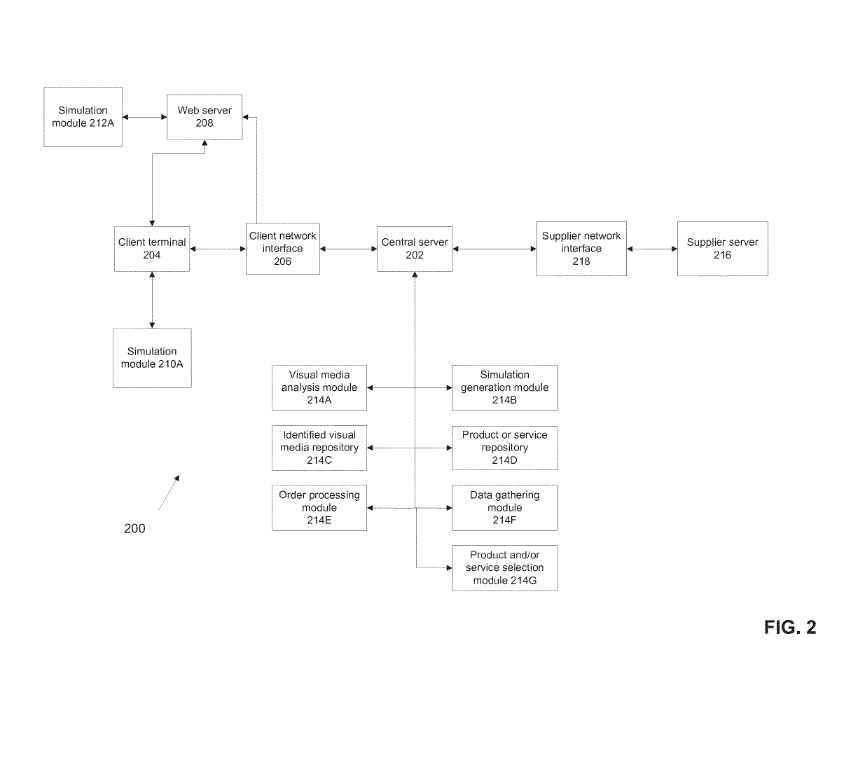

Reference is now made to FIG. 1, which is a flowchart of a method of presenting a simulation(s) of customized products and/or services to a browsing user within a web document the user is currently browsing, based on visual media extracted from the web document the user is currently browsing, in accordance with some embodiments of the present invention. Reference is also made to FIG. 2, which is a block diagram of a system for presenting a simulation(s) of customized products and/or services to a browsing user within a web document the user is currently browsing, based on visual media extracted from the web document the user is currently browsing, in accordance with some embodiments of the present invention.

It is noted that the systems and/or methods described herein are not necessarily limited to identifying and/or extracting visual media from the webpage the user is currently browsing. Visual media may be automatically obtained from other sources associated with the user as described herein, for example, visual media from social network sites of the user, visual media from social networks of friends and/or other people associated with the user (for example, following links from the social network to site of the user to access pictures of friends of the user from the social network site of each respective user) visual media from previous webpages that the user browsed, and/or visual media from other pages having the same domain as the page the user is currently browsing. The visual media themselves may be located at different locations, for example, locally at the server hosting the web document being browsed, remotely at a storage location (e.g., accessed by a link), or on the client terminal itself (e.g., stored from a previous view).

The systems and/or methods described herein provide the browsing user with customized products or services that are estimated to be of interest to the user, based on visual media that are estimated to be interesting to the user from the webpage that the user is currently visiting. The user may quickly purchase physical items or order services directly from the currently webpage and/or the website the user was directed to, without having to specifically visit a different on-online store from the outset. The systems and/or methods described herein may improve performance of a computer (e.g., improved computation efficiency and/or less resource requirements), as the user does not have to go through the entire process of selecting a desired item and/or selecting and/or uploading a desired picture, as a preview of the visual media applied onto the product is automatically provided to the user. For example, a user browses an on-line blog dedicated to dogs, that today includes a funny picture of a dog chewing on a shoe. The user may be presented with a simulation including the image of the dog chewing on the shoe overlaid on a t-shirt. The user may quickly purchase the t-shirt with the dog picture printed thereon, by clicking on the interactive user interface displaying the simulation.

System 200 includes a central server 202 configured to communicate with multiple client terminals 204 over a network, for example, the internet. Exemplary client terminals 204 include mobile devices, smartphones, tablets, laptop computers, desktop computers, thin clients (that depends on applications on a network connected server) and kiosks. Client terminal 204 has installed thereon a browser module configured to browse web documents. Client terminal 204 includes communication elements for communication with server 202, optionally over a wireless network.

An optional client network interface 206 of server 202 is configured to transmit to and/or receive data from client terminals 202 over the network.

Optionally, processing is performed at central server 202, with presentation of the simulation of the customized product at client terminal 204. Alternatively or additionally, processing is performed at client terminal 204. The module(s) performing the processing (for example, a simulation module 210A) may be downloaded from server 202 for local installation on client terminal 204, and/or other suitable processing technology that may be provided to the terminal client for local execution, with or without local installation. Simulation module 210A may be installed, for example, as an add-on to a website, as a browser extension, based on other methods of presenting data within the browser, as a desktop application configured to present the simulation, as a mobile application configured to present the simulation, and/or as a native mobile application configured to present the simulation.

Alternatively or additionally, processing is performed at a web server 208 hosting the webpage the user is browsing, optionally using a simulation module 212A.

Additional elements of system 200 are described herein.

Optionally, at 102, a user browses a webpage, for example, using client terminal 204 accessing certain web server 208 through a network. The webpage may include one or more visual media items, for example, a news site including a logo of the news reporting company, a blog including pictures related to the blogging topic, a webpage of a travel destination including a video of a trip, a social network webpage including personal pictures of the user, a company webpage including company emblems, a non-profit organization webpage including company symbols, and a school or college webpage including pictures of the campus.

Optionally, at 104, data from the webpage browsed at client terminal 204 is prepared for analysis to identify one or more visual media.

Alternatively or additionally, data is obtained from other sources, for example, other webpages on the same hosting site, other websites, from remote services (e.g., user access to cloud storage such as a drop-box, with or without client terminal application for accessing the storage), based on cookies on the client terminal, and/or based on other suitable terminal client and/or user data storage or application data (such as cookies or local storage of the websites and/or applications) and/or the user's local data storage (e.g., file system and/or other storage methods on the desktop or mobile application, such as photo album of the mobile device). Optionally, the data is transmitted to the location where the data will be analyzed. Optionally, the webpage to data is transmitted to central server 202, optionally by simulation module 210A installed on client terminal 204. Module 210A may be an installed extension to browser software stored on client terminal 204, for example, installed as a plug-in. Module 210A may be installed as a desktop application that overtakes the control over the browser. Module 210A may be installed to interact with external application programming interfaces (API) (for example, located on remote servers) to perform the transmission.

The accessed data may be directly transmitted to server 202, and/or instructions of how to access the data may be transmitted. Web document data including visual media data may be transmitted to central sever 202 based on one or more methods, for example, based on the URI of the visual media and/or the web document, based on the URL of the visual media and/or the web document. Data may be stored on client terminal 204, at web server 208, and/or at a different remote server. The data may first be transmitted to the client terminal 204 for initial processing and/or editing, and then transmitted to central server 202.

Alternatively or additionally, the webpage data is transmitted to central server 202 from web server 208 hosting the webpage being browsed, optionally by simulation module 212A installed on web server 208. Module 212A may be installed as an add-on to the website itself, as an external API, and/or as a module running in the background behind the accessed webpage, and/or installed as an application on the client terminal (e.g., a mobile or desktop device).

Alternatively or additionally, the data is first processed on client terminal 204 (e.g., by module 210A) before transmission to central server 202, for example, the data undergoes image manipulation and/or image processing to prepare the visual media for integration. Alternatively or additionally, the URL of the visual media stored on web server 208 is used to access the visual media by client terminal 204 for the image manipulation. The manipulated image is then transmitted from client terminal 204 to server 202, optionally along with editing data and/or other instructions for server 202 to perform.

Alternatively or additionally, the webpage data is stored on a memory of client terminal 204 for local analysis.

Alternatively or additionally, the webpage data is analyzed at client terminal 204 (e.g., by module 210A) independently of the server, without providing the webpage data and/or results of the analysis to the server.

Alternatively or additionally, data from locations other than the current webpage being browsed is collected and/or prepared for analysis. Exemplary data sources may include:
Data from previously viewed webpages at the client terminal. The webpages the user visited may be downloaded and/or stored, and/or the respective URLs provided to server 202 for access. The previously visited webpages may be accessed based on a browsing history. When the user uses an extension and/or script injection, a local record of the visited sites containing relevant visual media may be used as the data source.
An API related to the user's visual media. The API may be accessed to access remote visual media. For example, an API provided by a social network site provides visual media URLs that the user has placed on his/her posts. The URL may be analyzed to obtain the related visual media, which may be personal pictures related to the user, as described herein.
Certain frame(s) from a video played at the client terminal. The video may be converted to an invisible canvas HTML5 container, from which individual image frames may be captured. Alternatively or additionally, the video (or a URL to access the video) is transmitted to sever 202 for selection of certain visual media.
Visual media stored on the client terminal (for example, within a photo-album), and/or visual media of the user stored remotely (for example, by following a link to an on-line storage belonging to the user). Such visual media may be accessed, for example, using a suitable application or a native operating system program that uses the file system to locate and/or access the visual media.
Visual media posted on social network sites (optionally accessed based on user approval).
Data from other applications stored on the client terminal.
Data from visual media previously presented to the user at the client terminal. Offline and/or online scraping of sites visited by the user and/or other visual media related to the user may be gathered.

The web document may include the visual media item presented together with the web document, such as the image being presented within the presented web document. Alternatively or additionally, the visual media item is presented to independent of the web document, such as being accessed by an external reference link and/or by data stored in cookies, and/or based on other methods.

The data described herein may be accessed and/or prepared for further analysis at the client terminal by a configured simulation module 210A of client terminal 204. The user may selectively provide authorization for module 210A to access the certain data sources of client terminal 204.

Alternatively or additionally, server 202 has stored thereon a data gathering module 214F configured to access remote sites and/or remote servers and gather data related to the client for analysis. For example, to access a social network site of the user and/or a social network profile of the user. The gathered data may be stored on publicly available sites. The user may provide permission for module 214F to access private sites to gather data, for example, providing a password to access the private site.

Simulation module 210A may be configured to transmit the accessed data to server 202.

Optionally, at 106, the webpage data and/or data obtained from other locations (as described in block 104) is analyzed to identify one or more visual media items.

Optionally, the data is analyzed to identify visual media items associated with the user of the client terminal, for example, a picture of: the user, the family of the user, the hometown of the user, the college of the user, a travel destination visited by the user, a car the user owns, a house of the user, and the work place of the user.

Visual media associated with the user may be identified, for example, based on the source location (e.g., from the social network profile page of the user and/or from the photo album of the user), and/or based on tags and/or metadata identifying the association of the visual media to the user (e.g., picture titled ‘family vacation’, picture tag ‘me’).

The received data may be analyzed to identify visual media having personal significance to the user and/or related to the user based on an analysis of one or more of: the browsing behavior of the user (e.g., preferred websites), a geographical location of the user (e.g., patterns in geographical locations based tracking the position of the mobile device), and/or a personal profile of the user (e.g., as provided on a personal website and/or a social network site). For example, the personal profile of the user may be accessed to learn that the user likes dogs. Visual media of dogs to may be identified for overlaying on customizable products. In another example, the user behavior may be analyzed to learn geographical patterns of the user based on the movement of the mobile device of the user, such as the user visiting campgrounds on weekends during the summer Visual media of the outdoors may be identified for overlaying on customizable products.

Optionally, the received data is filtered to remove offensive and/or inappropriate visual media, for example, pornographic items, other adult type items, terror promotion items, racist or other discriminatory items. The filtration may be performed, for example, based on an image content analysis of the content of the visual media, based on URL or other source location, and based on tags associated with the visual media. The filtration may be automatically performed based on one or more general rules to exclude the offensive and/or inappropriate content. The user may adjust the rules based on personal preference, for example, to allow adult visual media.

Optionally, the data and/or identified visual media are analyzed to identify one or more validated visual media suitable for physical application to a physical product.

Alternatively or additionally, the one or more validated visual media may be suitable for screen presentation as part of an advertisement to a service and/or of the physical product.

Optionally, the validated visual media are selected based on having a resolution suitable for printing clearly on the physical product, for example, above a predefined resolution threshold or within a resolution range. Alternatively or additionally, the validated visual media are selected based on having image dimensions suitable for printing clearly on the physical product, for example, above a predefined dimension threshold or within a dimension range, and/or within a suitable percentage range of the screen.

Alternatively or additionally, the validated visual media are selected based on a certain type. Visual media may be categorized into different types, for example, based on associated tags (manually or automatically placed by the user or webpage author). The tags may include descriptive information of the associated visual media item, for example, the name of the media item, date, location, relation to the user, relation to other people, and demographic information of the user (e.g. birthday). The visual media type may be automatically determined by image processing of the visual to media to recognize certain key feature. Exemplary visual media types include people, places, animals, sports, vacation, hobbies, and news.

A group of visual media items may be identified by a script, such as a JavaScript or an offline script. The script may scan the webpage code, for example, the hypertext markup language (HTML) document object model (DOM), for visual media and/or elements with background visual media tags. The group of visual media may be further analyzed to select a sub-group of validated visual media as described herein, for example, based on a set of rules defining the resolution and/or image dimensions.

Visual media may be identified based on file type, for example, JPEG, TIFF, BMP, CGM, SVG, SWF, MPO, PNG, or other raster formats, vector formats, compound formats, and/or stereo formats. Visual media extracted from frames of a video may be identified based on file type, for example, MOV, AVI, GIF, and WMV.

The webpage data may be analyzed upon being visited by the user.

The analysis to identify the visual media may be performed locally at client terminal 204 by module 210A, and/or remotely at central server 202, for example, by a visual media analysis module 214A.

The identified visual media may be accessed, for example, by using the visual media file uniform resource identifier (URI) and/or visual media data URL. The identified visual media may be accessed at web server 208 hosting the site, and/or downloaded to central server 202 for further processing, for example, to an identified visual media data repository 214C stored on and/or in communication with server 202. The identified visual media may be downloaded to client terminal 204 for further processing, optionally by simulation module 210A.

Optionally, at 107, a suitable product and/or service (either or both of which may be customizable or non-customizable) is selected to match the identified visual media item(s), for example, by a product and/or service selection module 214G. There may be multiple products and/or services available for generating the customized simulation, for example, numbering in the hundreds or thousands. Certain customized products may be unsuitable for having the visual media item applied thereon, for example, visually unappealing clash of colors, difficulty in printing complex images onto a rough surface, printed image not being visually apparent on the product (e.g., printing of a dark image on a black product may result in the image not being to distinguishable from the background), and adult content printed on publicly used products. Certain products and/or services (customizable or non-customizable) may be improper and/or irrelevant for certain users, for example, advertising of a car to a child, advertising of female services (e.g., hair salon, cosmetics, obstetrics) to a male, and advertising of heavy winter coats to a user living in a region with a warm climate.

Optionally, the matching is performed to try and select the most suitable product for the identified visual media item. Optionally, the matching is performed based on an analysis of visual properties of the identified visual media item, for example, the colors, the distribution of colors, the shading, the shape of the item, and the visual complexity of the item. One or more suitable products and/or services may be selected based on the visual analysis, to generate visually appealing customized products, and/or visually appealing simulations. The visual media item may be matched with printable media on which the content will be printed. Alternatively or additionally, the matching is performed based on an analysis of a profile of the user, such as a demographic profile and/or a behavior profile. For example, based on the age of the user, the gender of the user, and the geographical location of the user. The product may be selected based on the relevance and/or suitability of the content of the image to the user.

At 108, a simulation of one or more products or a simulation of a service having the identified visual media integrated therein is generated, optionally by simulation generation module 214B of server 202 and/or by simulation module 210A of client terminal 204.

The visual media overlay may be overlaid on and/or embedded within the representation of the available product or service.

Visual media may be displayed on the physical product and/or integrated within the physical product, as a preview of how the final manufactured product will look like with the visual media printed on the physical product. Visual media, such as images associated with the user, for example, the picture of the user, may be displayed as embedded and/or overlaid within an advertisement for a certain service. For example, the picture of the user may be integrated within a scene of a beautiful beach as part of an advertisement for an island resort getaway vacation package.

The simulation may include: visual media integrated with generic products to create a preview of a customized product (based on printing the visual media on the to product, or based on other non-printing based integration methods); visual media presented together with images of non-customizable products for promotion of the non-customizable product itself (for example, cars, jewelry, hats and shoes); and/or visual media presented with services which may or may not have related physical items and/or digital representations (for example, vacation, coupons, and music).

The non-customized product products may be physical (for example, a car) or digital (for example, software, digital image, digital movie). The service may be digital (for example, software as a service (SAAS) service, a gambling website, an online show) or physical-based (for example, a vacation, or a movie playing at a theater).

The representations of available customizable products and/or services (for example, images and/or videos) may be stored in a product or service data repository 214D connected to and/or on central server 202, and/or provided by a remote server such as an advertising server or a server of an external entity. Repository 214D may access the remote server to obtain the generic version of the product or service representation, which is then customized with the visual media as part of the simulation generation.

The certain representation of the available customizable product may be selected, for example, randomly, based on available inventory, as a first come first serve basis, as provided by the advertising server, based on popular demand, and based on estimated demand of the browsing user.

The available products may be offered by a single supplier, or represent multiple offerings by different suppliers, for example, different printing shops able to print visual media on different physical products, and/or both physical item suppliers and service providers.

Visual media may be displayed on products in different ways. Each generated simulation may include, for example: a single visual media overlaid on a single product, multiple different visual media overlaid on a single product (e.g., a poster, a photo-album with multiple pages), a single visual media overlaid on multiple different product types, and/or multiple different visual media overlaid on multiple different product types.

Multiple visual media may be displayed on the single product or service as a to collage of images, tiled images, and/or integrated together, for example, a photo of a spouse of the user is integrated with an image of a gift (e.g., the spouse wearing a necklace or holding flowers), inviting the user to buy the gift for his/her spouse. For example, the photos (some or all) of friends obtained from a social network site of the user may be arranged together on a single advertisement promoting a service (for example, insurance or a vacation) or a product. When multiple images displayed together on the single product or service, the multiple images may be obtained from different sources, for example, some images are visual elements of the web site and some images are obtained from links on a social network website of the user and/or from the user.

The displayed product having the visual media overlaid thereon may be periodically changed and/or changed multiple times, for example, the changes occurring after a predefined period of time, the changes occurring while the webpage is presented, the changes occurring during browsing of the webpage by the user, and/or the change occurring during different accesses of the webpage.

Alternatively, the generated simulation includes visual media integrated with representation of non-customizable products and/or non-customizable services. Such non-customizable products are available for generic purchase, without the ability to integrate the visual media. For example, physical products (for example, cars, computers, and furniture) and/or services (for example, insurance, investment funds, healthcare providers, and carpet cleaning). The simulation containing visual media that are familiar and/or related to the user may help improve sales of the non-customized products and/or services to the browsing user, for example, by improving the personal appeal of the product or service to the browsing user.

At 110, the simulation is provided for presentation, such as for display to the user on a screen of client terminal 204, for example, by network interface 206, and/or by module 210A when the simulation has been locally generated on client terminal 204. The simulation is optionally presented in an interactive user interface set to be added to a browsed web document. The simulation may be presented within a window, sub-window, modal, appearing in the web document or based on other suitable methods for combining the generated simulation with the web document or the mobile application. The simulation including the visual media may be presented on the same browsed web document from which the visual media was extracted.

Optionally, the simulated media is presented to the user based on a set of predefined rules, for example, based on resolution of the visual element, based on resolution of the web document, based on automatic recognition of the image, based on identifying certain tags, based on URL, based on a certain size of the web browser window, based on the time of day, based on instructions from an advertizing engine, based on instructions from the central server, based on instruction from a local or external control unit, and/or based on network connectivity. When the set of rules has been met, the simulation is automatically presented. Alternatively, the simulation is presented based on the user performing one or more predefined actions, for example, hovering a cursor above certain items and/or above predefined locations within the webpage, and/or clicking certain items within the webpage.

Optionally, icons, buttons and/or other user interface elements are located onto the webpage. When the user hovers a cursor over the elements or clicks the elements, the presentation of the simulation is triggered, for example, an icon or message stating “Print Ordering Button” is located near or onto some or all of the visual media items in the webpage. Hovering or other method of touching such buttons trigger the simulated presentation of the related visual media item presented on customized products to be purchased, as described herein. A click on the simulation may trigger another simulation.

The simulation of the available product provides a preview of what the physical product looks like when the selected image is printed or otherwise applied to the physical product, to a digital representation of the service, and/or to a physical item related to the service (for example, a printed out ticket to a show). The simulation of the available service may provide a temptation for the user to select the service and/or non-customizable product, for example, when the picture of the user has been embedded within the service and/or non-customizable product, depicting the user using the service and/or non-customizable product.

A single simulation may be provided or multiple simulations may be provided, for simultaneous display, or for periodic changing of the display to show different simulations.

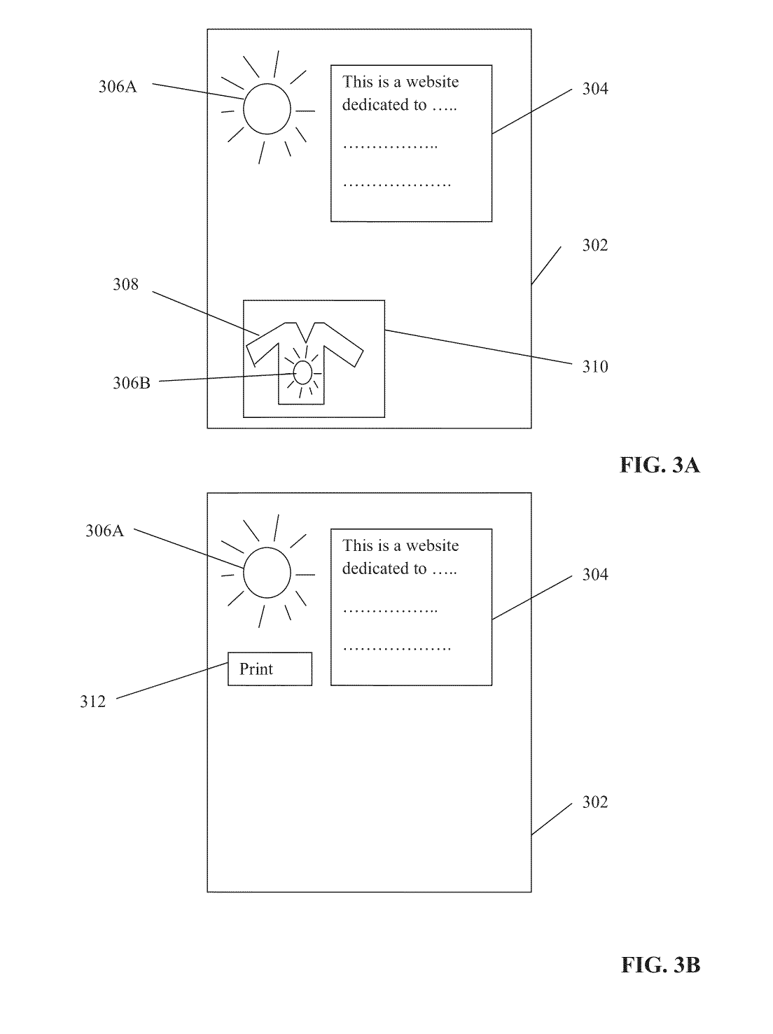

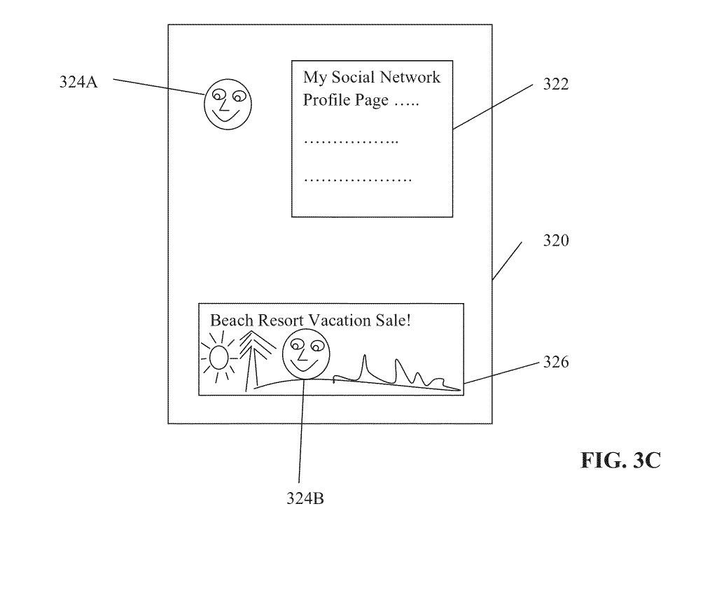

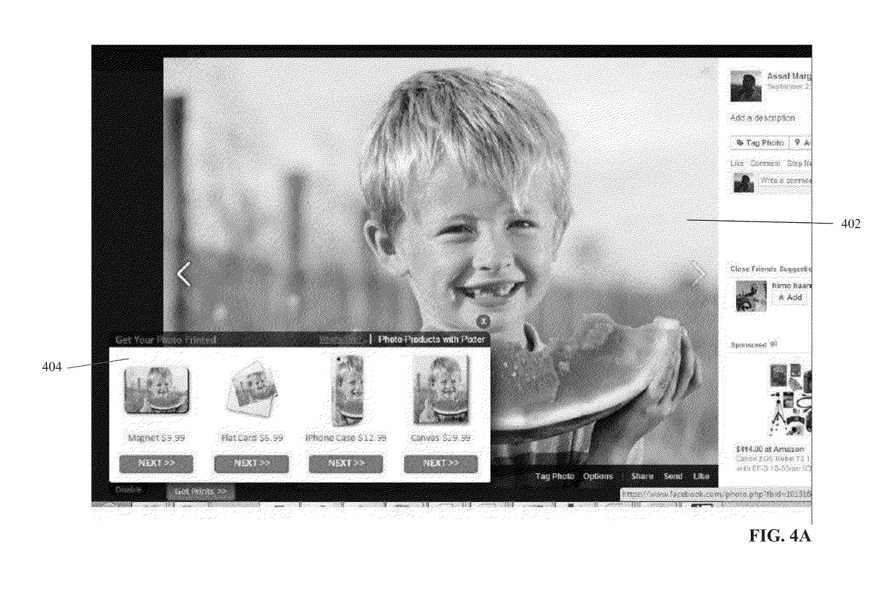

Reference is now made to FIGS. 3A-3C, which are schematic diagrams depicting different simulations of the identified visual media integrated within the product or service representation, in accordance with some embodiments of the to present invention. The schematic diagrams of FIGS. 3A-3C may be presented on the screen of client terminal 204, for example, within a viewing window or sub-window of a web-browser. The window or sub-window serves as an interactive user interface set to be added to the browsed web document. The user may order the displayed simulated visual media integrated within the product or the presented service through the window.

FIG. 3A depicts a webpage 302, which may include content collectively represented by box 304, for example, text, images, videos, sound files, and links. Webpage 302 include one or more visual media 306A for integration with a product representation, optionally validated visual media as described herein.

A simulation 306B of visual media 306A integrated within an image of a product 308 (shown as a t-shirt for example purposes) is displayed in a window 310. Window 310 is added to the same webpage 302 from which identified visual media 306A has been extracted.

FIG. 3B depicts webpage 302 with contents 304 and visual media 306A. An icon 312 (for example, stating “Print”) is displayed in proximity to identified visual media 306A, or within visual media 306A. When the user clicks or hovers a cursor above icon 312, a simulation 306B of visual media 306A integrated within product 308 corresponding to the icon is displayed as described with reference to FIG. 3A. Each visual media item (or certain selected visual media items, such as validated visual media) may have corresponding icons, allowing the user to preview simulations of each respective visual media on the same and/or different products. Icons may be displayed in proximity to visual media after the validation process. Optionally, only visual media that have been determined to be validated visual media may have related icons.

FIG. 3C depicts a user profile webpage 320, for example, of a social network site. Webpage 320 contains content 322 and one or more visual media 324A related to the user, for example, a photo of the user. Window 326 contains a simulation that includes a representation of a service, for example, an advertisement to a beach vacation that includes a picture of a beautiful beach. The simulation within window 326, includes a picture of the user 324B (which is based on visual media 324A) integrated within the picture of the beach. The user viewing the advertisement within to window 326, seeing his/her own picture 324B at the beautiful beach may be more likely to purchase the beach vacation.

Referring now back to FIG. 1 block 110, the generated simulation may be displayed within the webpage by a configured simulation module 210A and/or 212A, for example, based on a JavaScript and/or the <canvas> element of HTML5.

The generated simulation may be displayed within an interactive user interface set to be added to the browsed web document.

Optionally, the interactive user interface is added as a window to the browsed web document. Alternatively, an icon is first added to the browsed web document, within displaying the simulation. The simulation may be displayed after the interactive user interface is activated based on the displayed icon. For example, clicking the icon displays the interactive user interface containing the simulation.

Simulation module 210A and/or 212A may be configured to present the icon in proximity to one or more identified visual media, for example, by wrapping the identified visual media with an HTML DIV tag. The wrapping does not interfere with the presentation of the identified visual media, while allowing module 210A and/or 212A to inject the icon element. The icon element may be positioned, for example, in an absolute manner based on the web site (for example, top, left, bottom, and right), such as using Cascading Style Sheets (CSS).

Optionally, at 112, a command is received indication selection of a certain product or service having the overlaid image, for example, the user manually clicks the window containing the simulation displayed within the browsed webpage on the screen of client terminal 204. The command may be transmitted by simulation module 210A to central server 202, optionally via client network interface 206. Alternatively or additionally, the command is received and processed locally at client terminal 204, for example, by module 210A.

The simulated media (i.e., within the banner or window) may direct the user to an online shop (located on a different external web server) to purchase the product or service within the same banner or same window on the web document, or within another banner or window on the same web document. The purchase may be made based on a direct sale method, an affiliate sale method, based on a landing page that appears, based on an advertisement that appears, for the purpose of collecting data, or for other purposes.

An optional order processing module 214E (or locally stored simulation module 210A) is configured to receive the command to select the product or service, and initiate a checkout process. A JavaScript running as part of module 210A and/or 214E may be invoked by the user selection.

Optionally, the checkout process includes a detailed preview of the selected product. The detailed preview may be displayed on the screen of client terminal 204. The user may be provided with functions to edit the visual medial (e.g., image) for printing (or other method of application) on the product. Exemplary image editing functions include one or more of: crop, rotate, zoom in (i.e., enlarge), zoom out (i.e., shrink), reposition on the product, brighten, darken, sharpen, add various masks, and/or add various effects.

Alternatively or additionally, the user may select a different version of the displayed product, for example, a different size, a different color, a variation in design of the product (for example, t-shirt with ‘v’ neck), and/or a different type of product (for example, t-shirt instead of mug).

The edited visual media may be saved on a memory of client terminal 204 and/or server 202. The edited visual media may be saved as a new DataURL or the rest of the checkout process, for example, for use in thumbnails and/or previews during the checkout.

Order processing module 214E (or another module) may be configured to calculate the net price, for example, for each individual unit, a bulk discount when multiple units are purchased, shipping costs, and/or coupon data. The check out process may be implemented based on various AJAX and/or JSONP calls made to obtain dynamic JSON data from another remote server (such as from supplier servers) and/or other APIs. The prices may a static part of the Javascript or otherwise configured at the payment clearance supplier, or based on other methods.

Alternatively or additionally, the user is forwarded (via central server 202 or directly from client terminal 204) to a respective supplier server 216 for completion of the checkout process after selection of a certain product provided by the respective supplier. An optional a supplier network interface 218 of central server 202 communicates with supplier server 216 over the network.

Optionally, at 114, a work order is issued to a respective product provider to provide the selected product and/or service. The work order may be transmitted from to central server 202 to the respective supplier server 216 via supplier network interface 218. The work order may be transmitted directly from client terminal 204 to the respective relevant supplier server 206 (optionally by module 210A), for example, based on APIs or other methods. The work order may include the visual media DataURL, any editing performed on the overlaid image, and other relevant data, such as shipping address of the user.

The work order may include work data defining the customized product, for example, images (which may be edited and/or re-formatted and/or cropped) and/or metadata required to create the customized product, the simulation of the customized product or service, images and/or metadata of the generic product, images and/or metadata of the visual element(s), and/or images and/or metadata of the integrated customized product, and/or other data such as shipping information.

The work order may be transmitted to the supplier, for example, through a remote server, through presentation on a certain user interface (and allowing access by the supplier to the data), by an email or other message format, and/or other suitable forms of communication.

The work product order may be transmitted to a manufacturing facility with instructions to manufacture the physical version of the selected product, including the identified visual media having any edited features applied to the physical product (for example, printed thereon. The work product order may be transmitted to a service facility with instruction to provide the service associated with the displayed product.

The work order may include an order to purchase the non-customized product within the customized simulation. The non-customized product may not require any customization, and may be provided from available inventory.

Optionally, at 116, the manufactured customized product, and/or the non-customized product, and/or service is provided to the user. The physical product may be shipped to an address provided by the user and/or made available for pickup by the user. Vouchers indicating purchase of the service (for example, plane tickets) may be shipped to an address provided by the user, made available for pickup by the user, and/or provided an address of the user (for example, a house cleaning service). Digital products and/or services (for example, software, digital photos, movies, access to an online gambling website) are provided to the user, for example, by providing the user with a link to a server storing the digital product and/or service, or downloading the to digital product and/or service to a local memory for local access by the user.

It is noted that the functions of blocks 104-114 may all be performed by the central server (e.g., by one or more modules 214A-F), may all be performed locally at the client terminal (e.g., by module 210A), and/or may be performed at web server 208 (e.g., by module 212A). Alternatively, some blocks may performed at the central server and some blocks locally executed at the client terminal and/or at the web server, parts of certain blocks may be performed at the server and other parts of the block performed at the client terminal and/or web server, and/or certain blocks may be performed both at the client terminal and at the server. Selection of where to perform the functions may be based on, for example, availability of bandwidth, availability of memory, availability of processor resources, privacy considerations, legal considerations, and/or personal preference of the user of the client terminal and/or operator of the web server.

The method of FIG. 1 may be performed by different architectures shown in FIG. 2. In one exemplary architecture multiple client terminals 204 transmit data to central server 202 for centralized processing. The generated simulation is then transmitted back from server 202 to each respective client terminal 204. In another exemplary architecture, each client terminal 204 downloads software from central server 202 for local installation (e.g., module 210A). Client terminal 204 may download software from a content delivery network (CDN). Server 202 may be part of the CDN, for access by the client terminal. The locally installed module may perform some or all functions described herein. The locally installed module may communicate with server 202, and/or communicate directly with relevant supplier servers 216, for example, using APIs or other methods. It is noted that both architectures may be possible (i.e., for different client terminals) in a single exemplary implementation.

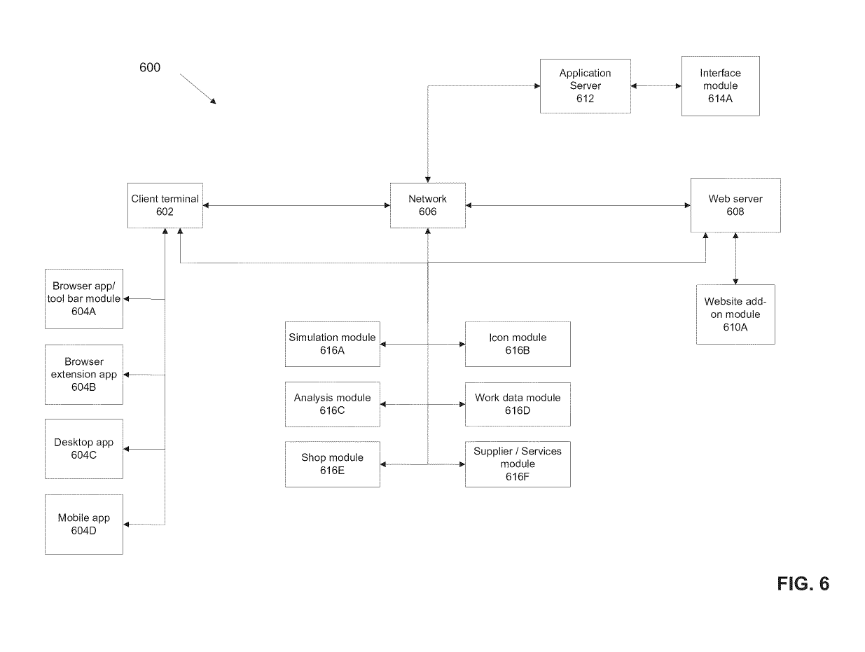

Reference is now made to FIG. 6, which is a block diagram of another exemplary system implementation, in accordance with some embodiments of the present invention. System 600 of FIG. 6 may execute the method of FIG. 1. System 600 of FIG. 6 may be a variation of the architecture of system 200 of FIG. 2, and/or may be integrated together (entirely or parts thereof) with system 200. System 600 depicts implementation based on the client terminal and/or webserver.

System 600 includes a client terminal 602 (as described herein) which may communicate with a web server 608 (as described herein) via a network 606.

Optionally, client terminal 602 communicates with an application server 612 storing applications for download and local execution on the client terminal, and/or for remote access from the client terminal.

System 600 depicts one or more of the following use cases which may be implemented by respective modules:
Browser app/TOOLBAR module 604A installed on client terminal 602, and/or other utilities installed on a browser or on the client terminal (and affect the browser) that locally offer services (as described herein) to users while visiting various websites with their browsers.
Add-on module 610A to a website installed on web server 608: An Add-on Website or Web-platform add to respective web sites in order to add functionality available to the website users. The users see the simulation only at the site the add-on is installed onto.
Browser extension module 604B installed on client terminal 602 and/or other utilities the users may install on their browsers or computers. Such extensions provide users with customized simulation onto various website they may visit.
Desktop app module 604C installed on client terminal 602 and/or other utilities the users may install on their computers. Such applications provide users with customized simulation onto various website they may visit as well as browsed by other computer software.
Interface module 614A installed on application server 612, for example, an SDK for a mobile app add to respective applications in order to add functionality to the apps, as described herein.
A mobile app 604D installed by the user to add general capability accessed from various apps.

Exemplary modules are now described, configured to perform one or more functions, for example, as described herein.

Simulation module 616A: a customized simulation Banner or other form that appears to the user in order to promote a certain product or service, as described herein. The simulation banner displays the defined media and the target media related to the customized product or the non customized product or the service. The user may hover or click or tap the simulation in order to trigger presentation of the promoted to products or services in a larger presentation window or with more information or in a way that enable purchase of the displayed product or service. The functionality of the Simulation module may include the functionality of one or more of the icon module, analysis module, work data module, and/or shop module described below.

Icon module 616B: A static or dynamic user interface (UI) element which is located on a web-page or app UI, as described herein. User interaction with the icon may trigger the Customized Simulation module. Such functionality may be a part of the simulation module and/or the analysis module.

Analysis module 616C: analyses the browed web-page or the related media defined and decides what shall be presented on the simulation and where such simulation shall be located, as described herein. The Icon may also be located and controlled by that module. Such module may be included in the simulation and/or icon modules.

Work data module 616D: as an outcome of the user product or service selection, the system creates work data to be communicated to the manufacturer or supplier. The work data includes the required details to produce the selected products or to supply specified products or services. The work data may include the selected images with or without editing and cropping changes and with or without other specifications such as the exact location of the image(s) onto the selected product(s).

The work data may be provided as a certain file formats (e.g., JPEG, PNG, PDF, Data URI, text) and/or links/URL to the location such images are located and/or metadata that includes one or more of the following: order specification, products selected, product specification, user address and other data, price, shipping address, relevant media location, statistical data about the purchase, the relevant business entities, the payment details and other related data. Work data that refers to a non customized product or to a service may include the images presented to the user, and/or metadata that refers to the described order. The work data is generated by one or more of the described modules. The work data may be generated by one or both of the client terminal and central server (when relevant). Part of the work data may be created on the client terminal and other parts at the server. The client terminal may send to the server the required information in order that the server creates the work data. The work data is transmitted either to a service supplier or to an affiliate or connected shop for the next steps of the order and fulfillment process. A work product order is sent from the client or from the server to the supplier for fulfillment and/or for payment and/or for both. The communication with the supplier may be by one or more of the following ways: client-to-server, server-to server communication, a user interface on the main server used by such supplier, email, API, FTP or any other way of communication.

Shop module 616E: presents UI elements and functions that enable the user to purchase the product and/or service. Shop 616E may include image editing tools, product catalog, user contact details, shipping address and payment services. Some or all parts of the shop might be a part of the simulation module. Some parts of the shop may reside on a server or on an affiliate or on supplier server.

Suppliers/services module 616F: Suppliers fulfillment service. The user may buy the products and/or services directly from the UI of the simulation module or may be directed to another shop. The user may be redirected to a shop presented in another window and/or at another URL and/or to a 3^{rd} party service (with or without affiliate agreement). The entity that managed the shop may manage the production of customized products or manage fulfillment of non-customized products or services or may manage communication with other supply service—directly or via a 3^{rd} party service.

Modules 616A-F may be installed on at least one of the browser on client terminal 602, on the desktop of client terminal 602, on the web server 608, on the central server (as described herein), on the mobile device (i.e., client terminal 604), on or on another remote server. The installation on one or more of the platforms may include the full software package, or part of the software is locally installed and other parts are fetched by the already installed software from a remote location (i.e. a JS or other type of code is called from a remote server or a CDN and run by the browser).

The calling software might be a part of the system or might be a part of another software that calls the simulation software. For example, the monetization software of a monetization company calls the customized simulation software to make such customized simulation available.

Exemplary installation scenarios of software modules include:
Local installation on a client terminal as a browser extension or desktop app. The installation may be complete or include specific modules that fetch any to additionally required software parts from remote storage sites such as CDN or remote servers or a central server. For example, as in the case of browser extension, desktop app, and/or mobile app.
Server installation, and temporarily download (for example, as a browser compatible asset such as HTML or Javascript) to the client terminal for processing and presentation purposes. The installation may be complete or include specific modules that fetch any additionally required software parts from remote storage sites such as CDN or remote servers. For example, as in the case of website add-on.
Locally installation and processing as needed, or as demanded by the hosting software or any other software carrier. The installation may be complete or include specific modules that fetch any additionally required software parts from remote storage sites such as CDN or remote servers or Central Server. For example, as in the case of Toolbar, other monetization solution, and Mobile SDK.

Computer readable program instructions configured to perform the method described herein may execute entirely on the user's computer, partly on the user's computer, as a stand-alone software package, partly on the user's computer, and/or partly on a remote computer or entirely on the remote computer or server.

Optionally or alternatively, the customized simulation is created and transmitted to users, for example, as an email, MMS, or other suitable method to deliver media. The relevant media data included in the customized simulation is fetched using one or more of the methods described herein. The images (or other visual media items) and the transmission address (e.g., email addresses, phone numbers, internet phone ID, instant message ID) are matched for sending the customized simulation as a message to the user.

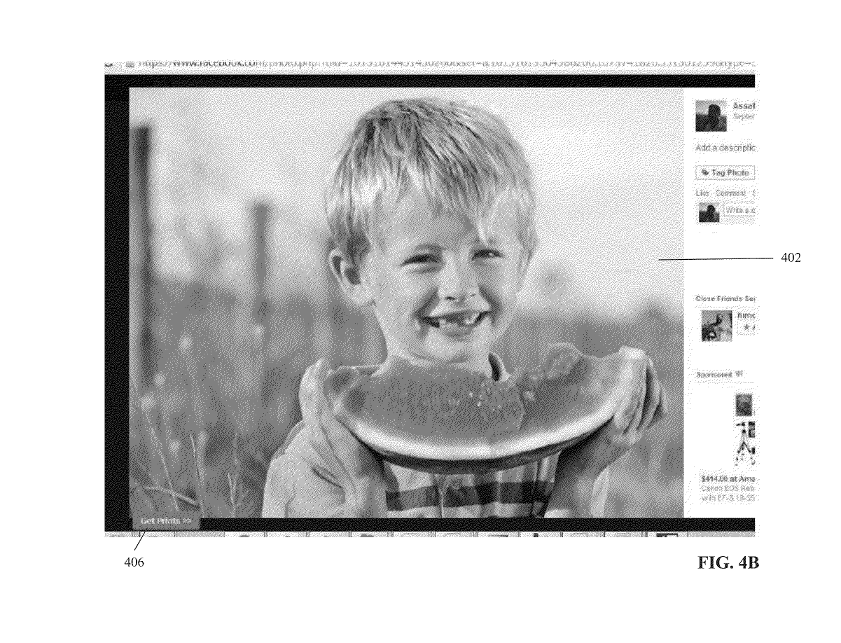

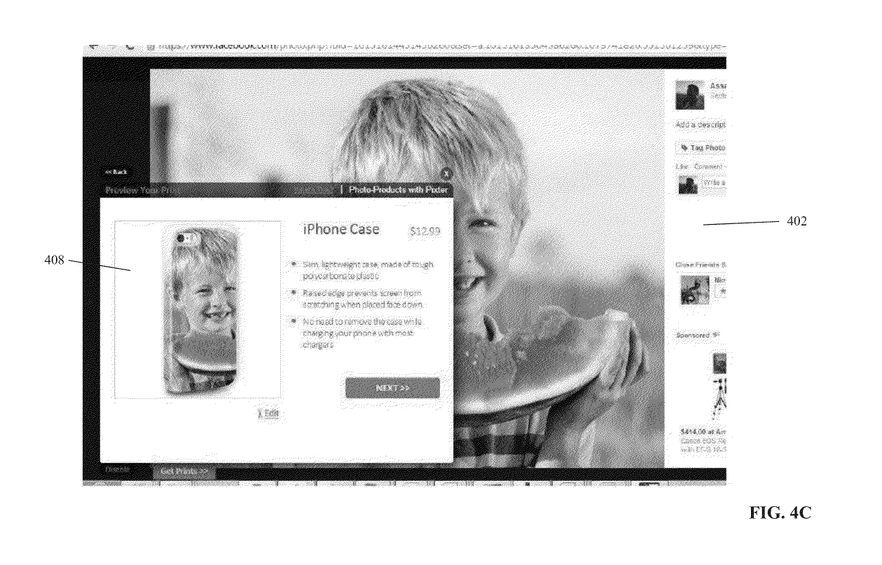

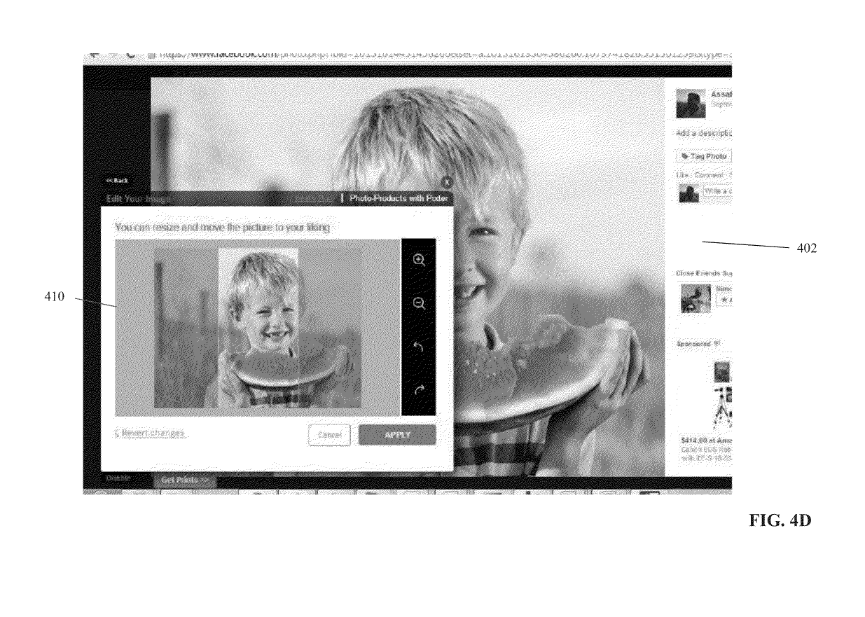

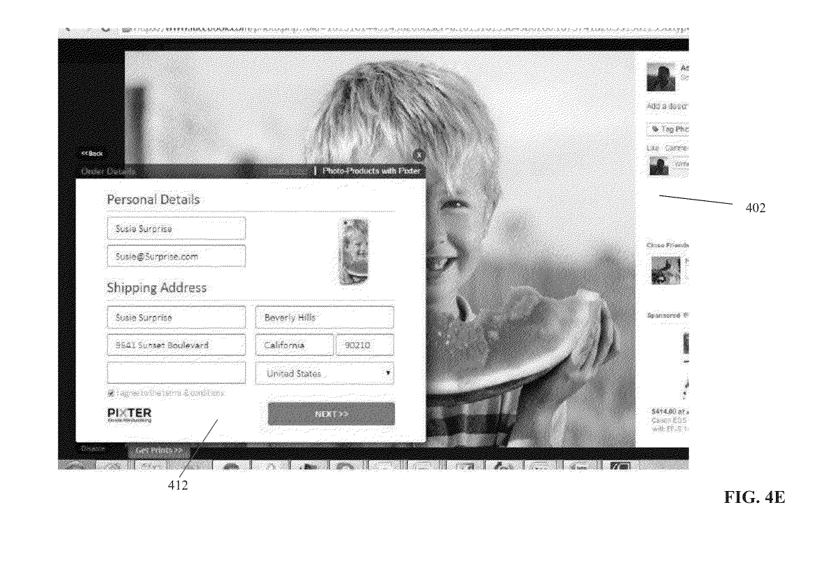

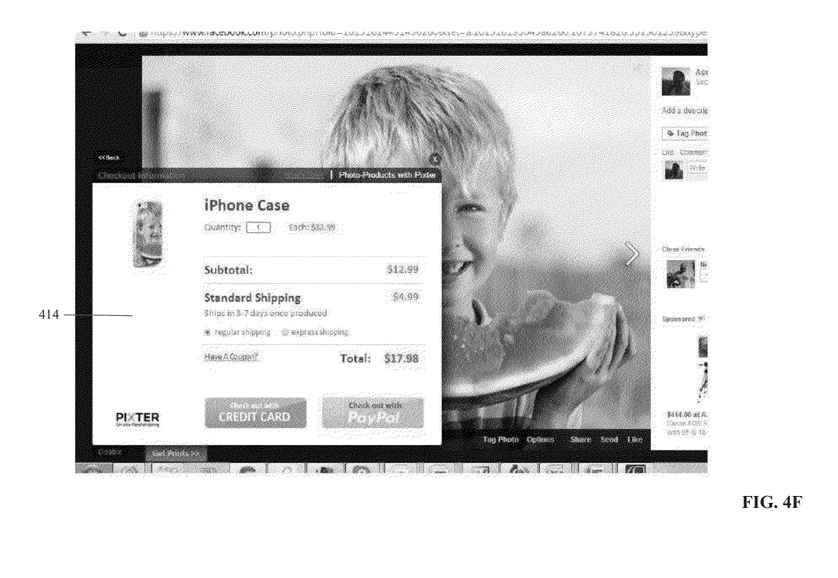

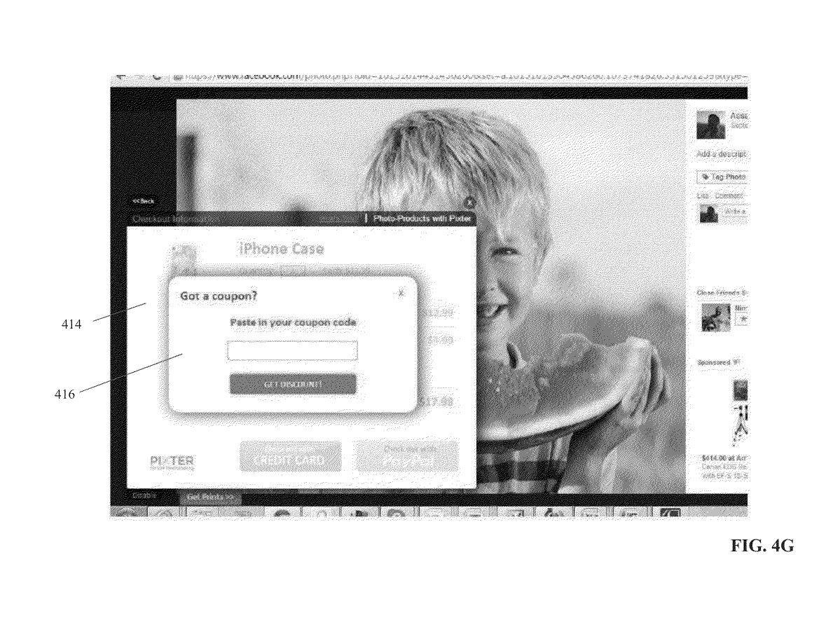

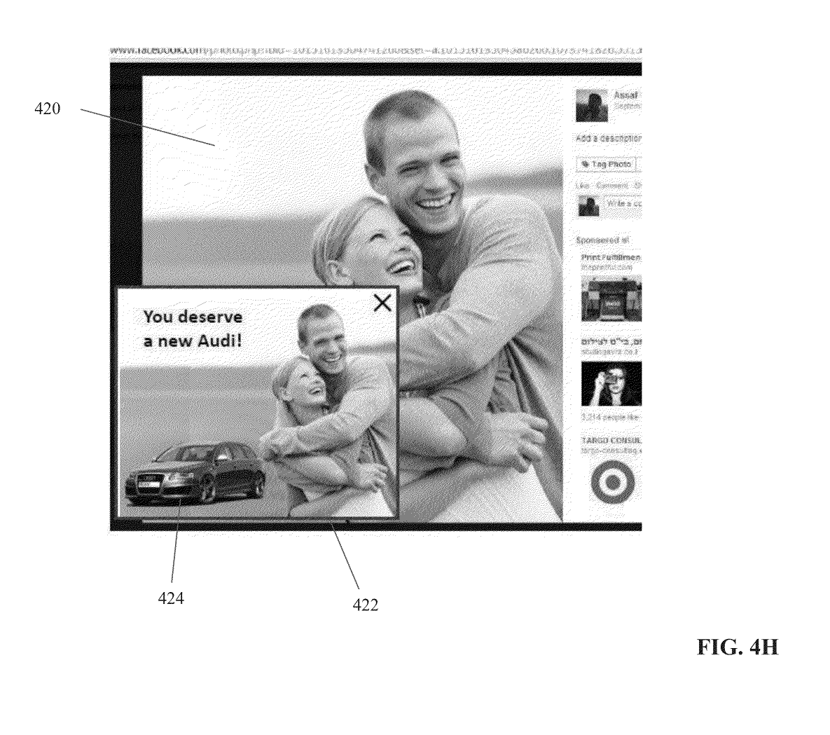

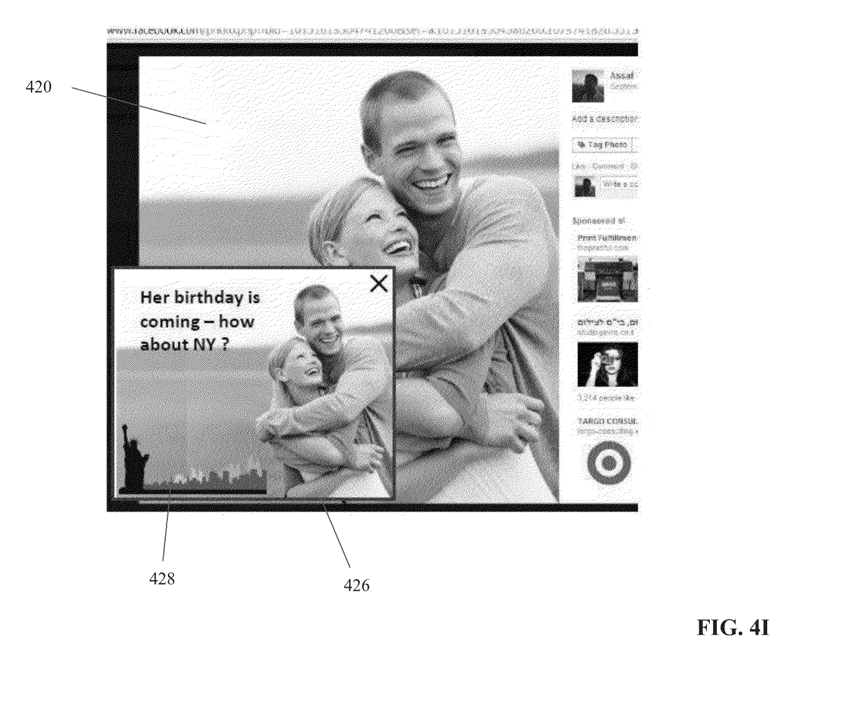

Reference is now made to FIGS. 4A-4I, which are screen captures of an exemplary implementation of the simulated customized product or service, in accordance with some embodiments of the present invention. The exemplary implementation is based on the methods and/or systems described herein and/or with reference to FIGS. 1-3.

FIG. 4A is a screen capture presented to a user viewing a web document 402, such as a blown up image within a personal webpage of a social network site. Web document 402 includes a visual element; an image of a child eating a watermelon. A window 404 including multiple simulations of the visual element (the picture of the child) applied to different items: a magnet, a flat card, a Smartphone case, and a canvas. Window 404 may include other information, for example, the price of each item, and links, such as ‘What's This?’ for more information, and ‘Next’ boxes to initiate the purchasing process.

Window 404 may be presented, optionally based on predefined rules, for example, as described with reference to block 110 of FIG. 1. The simulation within window 404 may be generated, for example, as described with reference to block 108 of FIG. 1. The image within web document 402 which is applied to the simulation may be a validated image, as described herein.

FIG. 4B is a screen capture of web document 402 having an icon 406 presented at the lower corner of the image of the child. Clicking and/or hovering the cursor above icon 406 and/or other parts of the image expands window 404, for example, as shown in FIG. 4A.

FIG. 4C is a screen capture of web document 402 when the smart phone case shown in window 404 of FIG. 4A has been selected. Preview window 408 provides additional product definition details, and a larger preview of the customized product. Window 408 provides the option to Edit the image, or continue the checkout process by clicking Next.

FIG. 4D is a screen capture when the Edit link has been clicked within FIG. 4C. Window 410 provides the ability to edit the visual element that will be applied to the selected product, as described herein. For example, window 410 provides the ability to select certain regions of the image for printing on the product, to increase or decrease the size of the image, and/or for changing the orientation of the image relative to the product.

FIG. 4E is a screen capture once the image editing of FIG. 4D has been completed, such as by pressing the Apply link. Window 412 displays fields for the user to provide to complete the order, such as person details of the purchaser, and shipping address.

FIG. 4F is a screen capture to continue the checkout process, shown in FIG. 4E. Window 414 displays a breakdown of the costs of the product, based on the quality of selected items and shipping type. Purchases may be made, for example, by credit card or through a third party website.

FIG. 4G is a screen capture that includes a coupon window 416 that appears to when the coupon link of window 414 has been clicked. Discount coupon codes may be entered using window 416.

FIG. 4H is a screen capture that depicts a customized simulation of a non-customized product. An image 420 of a man hugging a woman is retrieved, for example, when the user browses a certain web document. Image 420 may include the user, for example, retrieved from a personal profile page of the user. A window 422 automatically appears, presenting the customized simulation formed from image 420 and another image of a non-customized product, for example, a car 424. The simulation may include a customized text message to the user, linking the user with the presented product, for example, “you deserve a new car!”. The car may have been selected for suitability based on the user demographic profile, as described herein. The user may be inclined to purchased the car after seeing him/herself in the simulation with the car.

FIG. 4I is a screen capture that depicts a customized simulation of a service. Image 420 and data retrieved from other sources (e.g., user profile, online social profile) may be analyzed to identify that the man (which is also the current user) and the woman within the image are in a relationship, and that the woman's birthday is coming up soon. Window 426 presents the customized simulation formed from image 420, and another image depicting a service, for example, a New York City skyline 428 depicting a trip to New York. The simulation may include a customized text message to the user, linking the user with the service, for example, “Her birthday is coming up—how about a trip to NY?”.

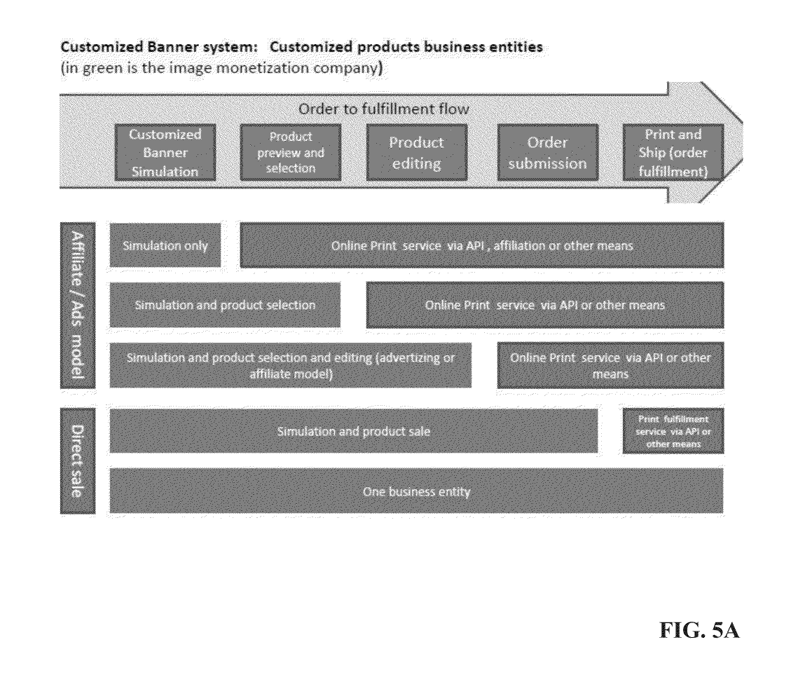

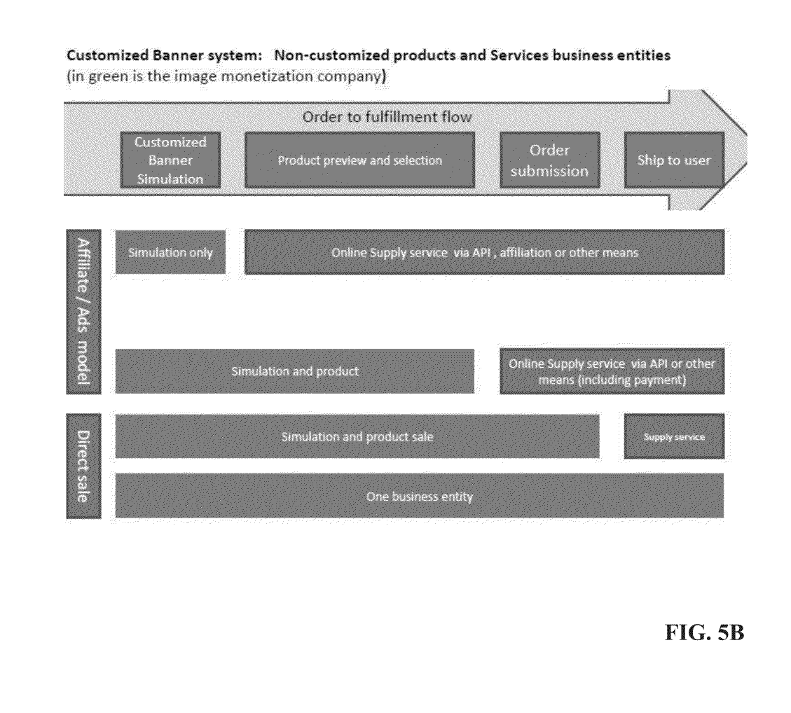

Reference is now made to FIG. 5A and FIG. 5B, which are charts depict exemplary financial models based on the systems and/or methods described herein, in accordance with some embodiments of the present invention.

FIG. 5A is a chart depicting an exemplary financial model for customized products. The order flow (as described herein) is summarized in the grey arrow: customized banner simulation, product preview and selection, product editing, order submission, and print and ship. The image monetization company may include one or more portions of the order flow as depicted in the chart: simulation only, simulation and product selection, simulation and product selection and editing, simulation and product sale, or the entire end to end process.

FIG. 5B is a chart depicting an exemplary financial model for non-customized products and services. The order flow (as described herein) is summarized in the grey arrow: customized banner simulation, product preview and selection, order submission, and ship to user. The image monetization company may include one or more portions of the order flow as depicted in the chart: simulation only, simulation and product, simulation and product sale, or the end to end process.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant client terminals, servers, and image file formats will be developed and the scope of the terms client terminal, server, and image are intended to include all to such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases to “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for simulating a product or service in an interactive user interface set to be added to a browsed web document, comprising:
receiving data from a web document browsed to by a browser installed at a client terminal;
analyzing the received data of the web document to identify at least one visual media item;
generating a simulation of at least one product or service having the identified at least one visual media item integrated therein; and
presenting the simulation at the client terminal within the browsed web document.

2. The method of claim 1, wherein the product is a customized product defined by the user.

3. The method of claim 1, wherein the simulation is presented within a customized banner displayed within the browsed web document.

4. The method of claim 1, further comprising receiving, from the client terminal, a manual command selected by a user based on an interactive user interface containing the presented simulation, the command indicating selection of the certain product or service having the integrated visual media item.

5. The method of claim 4, further comprising sending a work product order to at least one of a supplier and a manufacturing facility with instruction to manufacture or provide a physical version of the generated simulation, the physical version including the identified at least one visual media item physically applied to the product.

6. The method of claim 4, further comprising sending a work product order to at least one of a service and a facility with instruction to provide a service or a non-customized product based on the generated simulation.

7. The method of claim 4, further comprising displaying a detailed version of the generated simulation at the client terminal and providing editing functions to edit the integrated at least one visual media item for manufacturing.

8. The method of claim 1, wherein the generated simulation is automatically displayed in an interactive user interface added within the same web document from which the identified at least one visual media item has been extracted.

9. The method of claim 1, wherein the generated simulation is automatically displayed within the same web document from which the identified at least one visual media item as been extracted based on a predefined set of rules independent of user permission.

10. The method of claim 1, further comprising:
displaying an icon within the web document in proximity to the identified at least one visual media item before presentation of the simulation; and
presenting the simulation in response to a manual selection of the icon by a browsing user.

11. The method of claim 1, wherein the simulation is presented in response to at least one member selected from the group consisting of: a click of an icon, a click or hovering of the presented simulation, hovering a cursor over an icon, hovering a cursor over the presented simulation, a click of the at least one visual media item, and hovering the cursor over the at least one visual media item.

12. The method of claim 1, further comprising:
automatically gathering data for analysis from previously browsed web documents based on a browsing history stored at the client terminal.

13. The method of claim 1, wherein analyzing comprises analyzing the received data to identify an image of a user of the client terminal, and generating comprises generating the simulation including the image of the product or service having the image of the user integrated therein.

14. The method of claim 1, wherein analyzing comprises analyzing the received data of the web document to identify at least one validated image or other media item suitable for physical application to a physical product, wherein the at least one validated image includes at least one of a resolution above a predefined resolution threshold and image dimensions above a predefined dimension threshold.

15. The method of claim 1, wherein analyzing comprises analyzing the received data of the web document based on at least one tag associated with each respective visual media item to identify certain types of the at least one visual media item, the at least one tag including descriptive information of the respective visual media item.

16. The method of claim 1, wherein the generated simulation includes multiple different products each having the same identified visual media item and/or each having different identified visual media items integrated therein, for display at the client terminal.

17. The method of claim 1, wherein the generated simulation includes one or more product each having multiple different identified visual media items integrated therein, for display at the client terminal.

18. The method of claim 1, wherein one or both of the at least one product or service and the identified at least one visual media item integrated therein, are periodically changed while the web document is presented, to a different product or service and/or a different identified at least one visual media item integrated therein.

19. The method of claim 1, further comprising:
analyzing at least one of a browsing behavior, a geographical location, and a personal profile of a user accessing the web document;
wherein analyzing the received data comprising analyzing the received data of the web document to identify at least one image and/or relevant products and/or relevant services having personal significance to the user based on the analyzed at least one of behavior and profile of the user.

20. The method of claim 1, wherein the simulation comprises the product or service having a plurality of identified visual media items integrated therein as a collage.

21. The method of claim 1, wherein at least one of the receiving, the analyzing, and the generating are performed by software modules at a central server.

22. The method of claim 1, wherein at least one of the receiving, the analyzing, and the generating are performed by software modules at the client terminal.

23. The method of claim 1, further comprising filtering the received data to exclude offensive or inappropriate visual media items.

24. The method of claim 1, further comprising selecting a certain product or service based on one or both of suitability of the product or service to the user based on a demographic profile of the user, and an analysis of visual properties of the media item to form a visually appealing customized product with the certain product.

25. The method of claim 1, further comprising:
transmitting, from the client terminal, information for creation of work data to a server;
generating, at the server, the work data based on the information; and
transmitting the work data, from the server, to at least one of an affiliate and a connected shop, for order fulfillment processing.

26. The method of claim 1, further comprising:
triggering, based on selection of the simulation, a presentation of the product or service in a presentation window configured to enable purchase of the product or service through the presentation window.

27. The method of claim 1, wherein the simulation is delivered to the user as an email or an electronic message.

28. A system for simulating a product or service in an interactive user interface set to be added to a browsed web document, comprising:
a central server comprising:
a client network interface configured to communicate with at least one client terminal over a network and to receive data from a web document browsed to by a browser installed on the client terminal, the received data including at least one visual media item;
a product or service data repository configured to at least one of store and remotely access a plurality of product or service representations available from at least one product or service supplier; and
a simulation generation module configured to generate a simulation of at least one product or service representation from the repository having the at least one visual media item integrated therein, and to provide the simulation to the network interface for presentation within the browsed web document at the client terminal.

29. A system for simulating a product or service in an interactive user interface set to be added to a browsed web document, comprising:
a hardware processor;
a memory storing a script module containing program instructions for execution by the hardware processor, the script module including instructions for:
receiving data from a web document browsed to by a browser, the received data including at least one visual media item;
at least one of storing and remotely accessing a plurality of product or service representations available from at least one product or service supplier; and
generating a simulation of at least one product or service representation from a repository having the at least one visual media item integrated therein, and providing the simulation for presentation within the browsed web document;
wherein the hardware processor and the memory are included at one or both of a client terminal and a web server hosting the web document.

30. The system of claim 29, wherein the product is a customized product defined by the user.

31. The system of claim 29, wherein the script or part thereof is executed at the client terminal by a member selected from the group consisting of: browser application, toolbar, browser extension, and desktop application.

32. The system of claim 29, wherein the script or part thereof is executed at the web server as part of an add-on to the web document.

33. The system of claim 29, further comprising a visual media analysis module configured to analyze the received data to identify the at least one visual media item, the visual media analysis module configured for program execution on at least one of the web server and the client terminal.

34. The system of claim 29, wherein one or both of the web server and the client terminal are configured for sending a work product order to a supplier server of a certain supplier offering the product or service of the generated simulation, with instructions to manufacture a physical version of the product including the at least one visual media item for physical application to the product, or to provide a service represented within the simulation, or to provide a non-customized product represented within the simulation.

35. The system of claim 34, wherein the work product order includes metadata representing the details of the order.

36. The system of claim 29, wherein the data from the web document includes at least one member of a group consisting of: individual images, logos, symbols, emblems, photos, drawn illustrations, and rendered pictures.

37. The system of claim 29, further comprising a data gathering module for program execution at the client terminal or at the web server, the data gathering module configured to access data stored on the client terminal and/or at the web server and/or remotely accessed through the client terminal, and provide the accessed data and/or instructions of how to access the data for analysis.

38. The system of claim 37, wherein the simulation module is configured to access web document browsing history stored on the client terminal and/or at a remote server, and provide data from the browsed web documents for analysis.

39. The system of claim 37, wherein the simulation module is configured to access a plurality of visual media or URLs of the visual media stored at least one of on the client terminal and remotely, and provide the accessed plurality of visual media for further handling of user intent.

40. The system of claim 29, wherein at least one of the web server and the client terminal comprises a data gathering module configured to access at least one publicly available social network web document of a user of the client terminal to gather data for analysis.

41. The system of claim 29, wherein the web document includes the at least one visual media item presented together with the web document.

42. The system of claim 29, wherein the at least one visual media item is obtained independently of the web document.

43. The system of claim 29, wherein the client terminal is a mobile device with communication elements configured to wirelessly communicate with a central server.

44. The system of claim 29, further comprising a services module configured to redirect the user to a shop for purchase of the presented product or service, the shop presented in at least one of: another window, at another URL, a third party service with an affiliate agreement, and a third party service without an affiliate agreement.

45. The system of claim 44, wherein the entity that manages the shop manages at least one of: production of customized products, fulfillment of non-customized products or services, and communication with other supply services directly or via the third party service.

46. A computer program product for computing a simulation of a customized product, a non-customized product, or a service, in an interactive user interface set to be added to a browsed web document, the computer program product comprising:
one or more non-transitory computer-readable storage mediums, and program instructions stored on at least one of the one or more storage mediums, the program instructions comprising:
program instructions for receiving data from a web document browsed to by a browser installed at a client terminal;
program instructions for analyzing the received data of the web document to identify at least one visual media item;
program instructions for generating a simulation of at least one product or service having the identified at least one visual media item integrated therein; and
program instructions for presenting the simulation at the client terminal within the browsed web document.

47. The computer program product of claim 46, wherein the product is a customized product defined by the user.

48. The computer program product of claim 46, wherein the computer program product is stored on a central server for download to a local installation on the client terminal.

49. The computer program product of claim 46, wherein the computer program product is stored on a first member selected from the group consisting of: on a remote server for remote access by a client terminal, locally on the client terminal, and on a content delivery network (CDN).

50. The computer program product of claim 49, wherein at least some of the program instructions of the computer program product are stored on the selected first member, and at least some of the remaining other program instructions of the computer program product are stored on at least one second member different from the first member, the at least one second member selected from the group consisting of: on a remote server for remote access by a client terminal, locally on the client terminal, and on a CDN.

51. The computer program product of claim 46, wherein the simulation is a customized banner designed to promote purchase at least one of: the presented customized product, the presented non-customized product, and the presented service.

52. The computer program product of claim 46, further comprising:
program instruction to directly trigger a purchase of the product and service or re-direct a user to an external server to continue the purchase process.

53. The computer program product of claim 46, wherein the computer program product or part thereof is configured for local program execution as part of at least one member selected from the group consisting of: a browser extension of a web browser stored on a client terminal, an add-on to a website site stored on a web-server, and a native mobile application stored on the client terminal.

54. A computerized method for matching a product or service to a visual media item in an interactive user interface set to be added to a browsed web document, comprising:
receiving at least one visual media item from a web document browsed to by a browser of a user installed at a client terminal;
selecting a certain product or service for a plurality of products or services based on one or both of suitability of the product or service to the user based on a demographic profile of the user, and an analysis of visual properties of the media item to form a visually appealing customized product with the certain product;
generating a simulation of at least one product or service having the identified at least one visual media item integrated therein; and
presenting the simulation at the client terminal within the browsed web document.

55. The method of claim 54, wherein the product is selected to form a visually appealing customizable product formed by having the visual media item printed on the selected product.
